(19) United States
(12) Patent Application Publication
(10) Pub. No.: US 2025/0094465 A1
(43) Pub. Date: Mar. 20, 2025

(54) EXECUTING AN EXECUTION PLAN WITH A DIGITAL ASSISTANT AND USING LARGE LANGUAGE MODELS

(71) Applicant: Oracle International Corporation, Redwood Shores, CA (US)

(72) Inventors: Xin Xu, San Jose, CA (US); Bhagya Gayathri Hettige, Melbourne (AU); Srinivasa Phani Kumar Gadde, Fremont, CA (US); Yakupitiyage Don Thanuja Samodhye Dharmasiri, Melbourne (AU); Vanshika Sridharan, San Mateo, CA (US); Vishal Vishnoi, Redwood City, CA (US); Mark Edward Johnson, Sydney (AU)

(73) Assignee: Oracle International Corporation, Redwood Shores, CA (US)

(21) Appl. No.: 18/825,573

(22) Filed: Sep. 5, 2024

Related U.S. Application Data
(60) Provisional application No. 63/583,028, filed on Sep. 15, 2023.

(51) Int. Cl. G06F 16/33; G06F 16/383

(52) U.S. Cl. CPC G06F 16/3344; G06F 16/383

(57) ABSTRACT

Techniques are disclosed herein for executing an execution plan for a digital assistant with generative artificial intelligence (genAI). A first genAI model can generate a list of executable actions based on an utterance provided by a user. An execution plan can be generated to include the executable actions. The execution plan can be executed by performing an iterative process for each of the executable actions. The iterative process can include identifying an action type, invoking one or more states, and executing, by the one or more states, the executable action using an asset to obtain an output. A second prompt can be generated based on the output obtained from executing each of the executable actions. A second genAI model can generate a response to the utterance based on the second prompt.

### CROSS-REFERENCE TO RELATED APPLICATION

The present application is a non-provisional application of and claims the benefit and priority under 35 U.S.C. 119 (e) of U.S. Provisional Application No. 63/583,028, filed on Sep. 15, 2023, the disclosure of which is incorporated herein by reference in its entirety for all purposes

### FIELD

The present disclosure relates generally to digital assistants, and more particularly, though not necessarily exclusively, to techniques for executing an execution plan for generating a response to an utterance using a digital assistant and large language models.

### BACKGROUND

Artificial intelligence (AI) has diverse applications, with a notable evolution in the realm of digital assistants or chatbots. Originally, many users sought instant reactions through instant messaging or chat platforms. Organizations, recognizing the potential for engagement, utilized these platforms to interact with entities, such as end users, in real-time conversations.

However, maintaining a live communication channel with entities through human service personnel proved to be costly for organizations. In response to this challenge, digital assistants or chatbots, also known as bots, emerged as a solution to simulate conversations with entities, particularly over the Internet. The bots enabled entities to engage with users through messaging apps they already used or other applications with messaging capabilities.

Initially, traditional chatbots relied on predefined skill or intent models, which required entities to communicate within a fixed set of keywords or commands. Unfortunately, this approach limited an ability of the bot to engage intelligently and contextually in live conversations, hindering its capacity for natural communication. Entities were constrained by having to use specific commands that the bot could understand, often leading to difficulties in conveying intention effectively.

The landscape has since transformed with the integration of Large Language Models (LLMs) into digital assistants or chatbots. LLMs are deep learning algorithms that can perform a variety of natural language processing (NLP) tasks. They use a neural network architecture called a transformer, which can learn from the patterns and structures of natural language and conduct more nuanced and contextually aware conversations for various domains and purposes. This evolution marks a significant shift from rigid keyword-based interactions to a more adaptive and intuitive communication experience compared to traditional chatbots, enhancing the overall capabilities of digital assistants or chatbots in understanding and responding to user queries.

### BRIEF SUMMARY

In various embodiments, a computer-implemented method can be used for generating a response to an utterance using a digital assistant. The method can include generating, by a first generative artificial intelligence model, a list that includes one or more executable actions based on a first prompt including a natural language utterance provided by a user. The method can include creating an execution plan including the one or more executable actions. The method can include executing the execution plan. Executing the execution plan may include performing an iterative process for each executable action of the one or more executable actions. The iterative process can include (i) identifying an action type for an executable action, (ii) invoking one or more states configured to execute the action type, and (iii) executing, by the one or more states, the executable action using an asset to obtain an output. The method can include generating a second prompt based on the output obtained from executing each of the one or more executable actions. The method can include generating, by a second generative artificial intelligence model, a response to the natural language utterance based on the second prompt.

In some embodiments, creating the execution plan can include performing an evaluation of the one or more executable actions. Additionally or alternatively, the evaluation can include evaluating the one or more executable actions based on one or more ongoing conversation paths initiated by the user and any currently active execution plans. Additionally or alternatively, creating the execution plan can include (i) when the evaluation determines that the natural language utterance is part of an ongoing conversation path, incorporating the one or more executable actions into a currently active execution plan associated with the ongoing conversation path, the currently active execution plan comprising an ordered list of the one or more executable actions and one or more prior actions, or (ii) when the evaluation determines the natural language utterance is not part of an ongoing conversation path, creating a new execution plan comprising an ordered list of the one or more executable actions.

In some embodiments, the iterative process can include (i) determining whether one or more parameters are available for the executable action, (ii) when the one or more parameters are available, invoking the one or more states and executing the executable action based on the one or more parameters; and (iii) when the one or more parameters for the executable action are not available, obtaining the one or more parameters that are not available and then invoking the one or more states and executing the executable action based on the one or more parameters.

In some embodiments, obtaining the one or more parameters can include generating a natural language request to the user to obtain the one or more parameters for the executable action, and receiving a response from the user comprising the one or more parameters.

In some embodiments, invoking one or more states configured to execute the action type can include (i) invoking a first state to identify that the executable action has not yet been executed to generate a response, and (ii) invoking a second state to determine whether one or more parameters are available for the executable action. Additionally or alternatively, executing the executable action using the asset to obtain the output can include invoking a third state to generate the output. Additionally or alternatively, the first state, the second state, and the third state can be different from one another.

In some embodiments, generating the list can include selecting the one or more executable actions from a list of candidate agent actions that are determined by using a semantic index. Additionally or alternatively, creating the execution plan can include (i) identifying, based at least in part on metadata associated with candidate agent actions within the list of candidate agent actions, the one or more executable actions that provide information or knowledge for generating the response to the natural language utterance, and (ii) generating a structured output for the execution plan by creating an ordered list of the one or more executable actions and a set of dependencies among the one or more executable actions.

In some embodiments, the iterative process can include determining that one or more dependencies exist between the executable action and at least one other executable action of the one or more executable actions based on the set of dependencies among the one or more executable actions. Additionally or alternatively, the executable action can be executed sequentially in accordance with the one or more dependencies determined to exist between the executable action and the at least one other executable action.

In various embodiments, a system is provided that includes one or more processors and one or more computer-readable media storing instructions which, when executed by the one or more processors, cause the system to perform part or all of various operations. The system can generate, by a first generative artificial intelligence model, a list including one or more executable actions based on a first prompt comprising a natural language utterance provided by a user. The system can create an execution plan including the one or more executable actions. The system can execute the execution plan, and executing the execution plan can include performing an iterative process for each executable action of the one or more executable actions. The iterative process can include (i) identifying an action type for an executable action, (ii) invoking one or more states configured to execute the action type, and (iii) executing, by the one or more states, the executable action using an asset to obtain an output. The system can generate a second prompt based on the output obtained from executing each of the one or more executable actions. The system can generate, by a second generative artificial intelligence model, a response to the natural language utterance based on the second prompt.

In various embodiments, one or more non-transitory computer-readable media are provided for storing instructions which, when executed by one or more processors, cause a system to perform part or all of various operations. The operations can include generating, by a first generative artificial intelligence model, a list including one or more executable actions based on a first prompt comprising a natural language utterance provided by a user. The operations can include creating an execution plan including the one or more executable actions. The operations can include executing the execution plan, and executing the execution plan can include performing an iterative process for each executable action of the one or more executable actions. The iterative process can include (i) identifying an action type for an executable action, (ii) invoking one or more states configured to execute the action type, and (iii) executing, by the one or more states, the executable action using an asset to obtain an output. The operations can include generating a second prompt based on the output obtained from executing each of the one or more executable actions. The operations can include generating, by a second generative artificial intelligence model, a response to the natural language utterance based on the second prompt.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment incorporating a chatbot system in accordance with various embodiments.

FIG. 2 is an exemplary architecture for an LLM-based digital assistant in accordance with various embodiments.

FIG. 3 is a simplified block diagram of a computing environment including a digital assistant that can execute an execution plan for responding to an utterance from a user in accordance with various embodiments.

FIG. 4 is a simplified block diagram illustrating a data flow for updating a semantic context and memory store for a digital assistant that can execute an execution plan for responding to an utterance from a user in accordance with various embodiments.

FIG. 5 is a simplified block diagram of an example of a data flow for planning a response to an utterance from a user using a digital assistant that can execute an execution plan in accordance with various embodiments.

FIG. 6 is a flowchart of a process for executing an execution plan using a digital assistant including generative artificial intelligence in accordance with various embodiments.

FIG. 7 is a block diagram illustrating one pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

Artificial intelligence techniques have broad applicability. For example, a digital assistant is an artificial intelligence driven interface that helps users accomplish a variety of tasks using natural language conversations. Conventionally, for each digital assistant, a customer may assemble one or more skills that are focused on specific types of tasks, such as tracking inventory, submitting timecards, and creating expense reports. When an end user engages with the digital assistant, the digital assistant evaluates the end user input for the intent of the user and routes the conversation to and from the appropriate skill based on the user's perceived intent. However, there are some disadvantages of traditional intent-based skills including a limited understanding of natural language, inability to handle unknown inputs, limited ability to hold natural conversations off script, and challenges integrating external knowledge.

The advent of large language models (LLMs) like GPT-4 has propelled the field of chatbot design to unprecedented levels of sophistication and overcome these disadvantages and others of traditional intent-based skills. An LLM is a neural network that employs a transformer architecture, specifically crafted for processing and generating sequential data, such as text or words in conversations. LLMs undergo training with extensive textual data, gradually honing their ability to generate text that closely mimics human-written or spoken language. While LLMs excel at predicting the next word in a sequence, it's important to note that their output isn't guaranteed to be entirely accurate. Their text generation relies on learned patterns and information from training data, which could be incomplete, erroneous, or outdated, as their knowledge is confined to their training dataset. LLMs don't possess the capability to recall facts from memory; instead, their focus is on generating text that appears contextually appropriate.

To address this limitation, LLMs can be enhanced with tools that grant them access to external knowledge sources and training them to understand and respond to user queries in a contextually relevant manner. This enhancement can be achieved through various means including knowledge graphs, custom knowledge bases, Application Programming Interfaces (APIs), web crawling or scraping, and the like. The enhanced LLMs are commonly referred to as “agents.” Once configured, the agent can be deployed in artificial intelligence base systems such as chatbot applications. Users interact with the chatbot, posing questions or making requests, and the agent generates responses based on a combination of its base LLM capabilities and access to the external knowledge. This combination of powerful language generation with access to real-time information allows chatbots to provide more accurate, relevant, and contextually appropriate responses across a wide range of applications and domains.

For each digital assistant, a user may assemble one or more agents. Agents, which can include, at least in part, one or more Large Language Models (LLMs), are individual bots that provide human-like conversation capabilities for various types of tasks, such as tracking inventory, submitting timecards, updating accounts, and creating expense reports. The agents are primarily defined using natural language. Users, such as developers, can create a functional agent by pointing the agent to assets such as Application Programming Interfaces (APIs), knowledge-based assets such as documents, URLs, images, etc., data stores, prior conversations, etc. The assets are imported to the agent, and then, because the agent is LLM-based, the user can customize the agent using natural language again to provide additional API customizations for dialog and routing/reasoning. The operations performed by an agent are realized via execution of one or more actions. An action can be an explicit one that's authored (e.g., action created for generating natural language text or audio response in reply to an authored natural language prompt such as the query-‘What is the impact of XYZ on my 401k Contribution limit?’) or an implicit one that is created when an asset is imported (e.g., actions created for Change Contribution and Get Contribution API, available through a API asset, configured to change a user's 401k contribution).

When an end user engages with the digital assistant, the digital assistant evaluates the end user input and routes the conversation to and from the appropriate agents. The digital assistant can be made available to end users through a variety of channels such as FACEBOOK® Messenger, SKYPE MOBILE® messenger, or a Short Message Service (SMS), as well as via an application interface that has been developed to include a digital assistant, e.g., using a digital assistant software development kit (SDK). Channels carry the chat back and forth from end users to the digital assistant and its various agents. During these back-and-forth exchanges, the selected agent receives the processed input in the form of a query and processes the query to generate a response. This is done by an LLM of the agent predicting the most contextually relevant and grammatically correct response based on its training data and the input (e.g., the query and configuration data) it receives. The generated response may undergo post-processing to ensure it adheres to guidelines, policies, and formatting standards. This step helps make the response more coherent and user-friendly. The final response is delivered to the user through the appropriate channel, whether it's a text-based chat interface, a voice-based system, or another medium. According to various embodiments, the digital assistant maintains the conversation context, allowing for further interactions and dynamic back-and-forth exchanges between the user and the agent where later interactions can build upon earlier interactions.

A digital assistant, such as the above-described digital assistant, may receive one or more inputs, such as utterances, from an end-user. The one or more inputs may indicate that the end-user desires more than one action, such as two actions, three actions, four actions, or more actions, to be executed by the digital assistant. For example, the end-user may input an utterance into the digital assistant that indicates that the end-user wants to order a pizza and that the end-user wants to know any specials relating to the pizza. Performing more than one action based on input to the digital assistant can be difficult. For example, determining a set of actions to execute, determining an order in which the actions are to be executed, and the like can be difficult. Accordingly, different approaches are needed to address these challenges and others.

An execution plan can be used to address the above-described problems. The digital assistant can include a planning module or can otherwise be communicatively coupled with a planning module that may be configured to generate an execution plan. The execution plan can include a set of actions to execute, an order in which to execute the set of actions, assets, such as APIs, knowledge, etc., to be used for executing the set of actions, and the like. The execution plan can be generated by a generative model, such as a large language model, in response to the digital assistant receiving input from an end-user. The generative model can receive an utterance from the input and can generate the execution plan based on the utterance. The digital assistant can receive the execution plan from the generative model and can execute the actions included in the execution plan. In some embodiments, using a generative model to generate the execution plan can enhance a functionality of the digital assistant by providing a more flexible experience for the end-user. For example, each and every possible action or combination of actions and sequences of actions may not need to be explicitly programed into the digital assistant. Additionally or alternatively, using the generative model can facilitate broader access to assets, knowledge and the like to allow the digital assistant to provide broader and higher quality responses to input from the end-user.

A digital assistant can use an execution plan to execute a set of actions in response to receiving input from an end-user. The end-user may input one or more utterances into the digital assistant, which may be configured to generate and transmit a response to the one or more utterances. In some embodiments, responding to the one or more utterances may involve the digital assistant executing the set of actions, which may include one action, two actions, three actions, four actions, or more actions. Each action may be associated with a different asset such as an API, a knowledge base, or the like. The digital assistant may use a generative model, such as a large language model, to generate an execution plan for generating and executing the execution plan.

The digital assistant, or a generative model associated therewith, may access a semantic context and memory store to receive a set of potential actions that the digital assistant can execute. In some embodiments, the digital assistant can semantically search the semantic context and memory store receive the set of potential actions, knowledge or a knowledge base, a set of assets associated with the set of potential actions, and the like. The digital assistant can cause the generative model to receive the set of potential actions and the input from the end-user, and the generative model may be configured to generate the execution plan. In some embodiments, the execution plan can include (i) a set of actions to be executed in response to the input from the end-user and/or (ii) an order in which to execute the set of actions in (i).

As used herein, when an action is “based on” something, this means the action is based at least in part on at least a part of the something. As used herein, the terms “similarly”, “substantially,” “approximately” and “about” are defined as being largely but not necessarily wholly what is specified (and include wholly what is specified) as understood by one of ordinary skill in the art. In any disclosed embodiment, the term “similarly”, “substantially,” “approximately,” or “about” may be substituted with “within [a percentage] of” what is specified, where the percentage includes 0.1, 1, 5, and 10 percent.

### Digital Assistant and Knowledge Dialog

A bot (also referred to as an agent, chatbot, chatterbot, or talkbot) is a computer program that can perform conversations with end users. The bot can generally respond to natural-language messages (e.g., questions or comments) through a messaging application that uses natural-language messages. Enterprises may use one or more bot systems to communicate with end users through a messaging application. The messaging application, which may be referred to as a channel, may be an end user preferred messaging application that the end user has already installed and familiar with. Thus, the end user does not need to download and install new applications in order to chat with the bot system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

In some examples, a bot system may be associated with a Uniform Resource Identifier (URI). The URI may identify the bot system using a string of characters. The URI may be used as a webhook for one or more messaging application systems. The URI may include, for example, a Uniform Resource Locator (URL) or a Uniform Resource Name (URN). The bot system may be designed to receive a message (e.g., a hypertext transfer protocol (HTTP) post call message) from a messaging application system. The HTTP post call message may be directed to the URI from the messaging application system. In some embodiments, the message may be different from a HTTP post call message. For example, the bot system may receive a message from a Short Message Service (SMS). While discussion herein may refer to communications that the bot system receives as a message, it should be understood that the message may be an HTTP post call message, a SMS message, or any other type of communication between two systems.

End users may interact with the bot system through a conversational interaction (sometimes referred to as a conversational user interface (UI)), just as interactions between people. In some cases, the interaction may include the end user saying “Hello” to the bot and the bot responding with a “Hi” and asking the end user how it can help. In some cases, the interaction may also be a transactional interaction with, for example, a banking bot, such as transferring money from one account to another; an informational interaction with, for example, a HR bot, such as checking for vacation balance; or an interaction with, for example, a retail bot, such as discussing returning purchased goods or seeking technical support.

In some embodiments, the bot system may intelligently handle end user interactions without interaction with an administrator or developer of the bot system. For example, an end user may send one or more messages to the bot system in order to achieve a desired goal. A message may include certain content, such as text, emojis, audio, image, video, or other method of conveying a message. In some embodiments, the bot system may convert the content into a standardized form (e.g., a representational state transfer (REST) or API call against enterprise services with the proper parameters) and generate a natural language response. The bot system may also prompt the end user for additional input parameters or request other additional information. In some embodiments, the bot system may also initiate communication with the end user, rather than passively responding to end user utterances. Described herein are various techniques for identifying an explicit invocation of a bot system and determining an input for the bot system being invoked. In certain embodiments, explicit invocation analysis is performed by a master bot based on detecting an invocation name in an utterance. In response to detection of the invocation name, the utterance may be refined or pre-processed for input to a bot that is identified to be associated with the invocation name and/or communication.

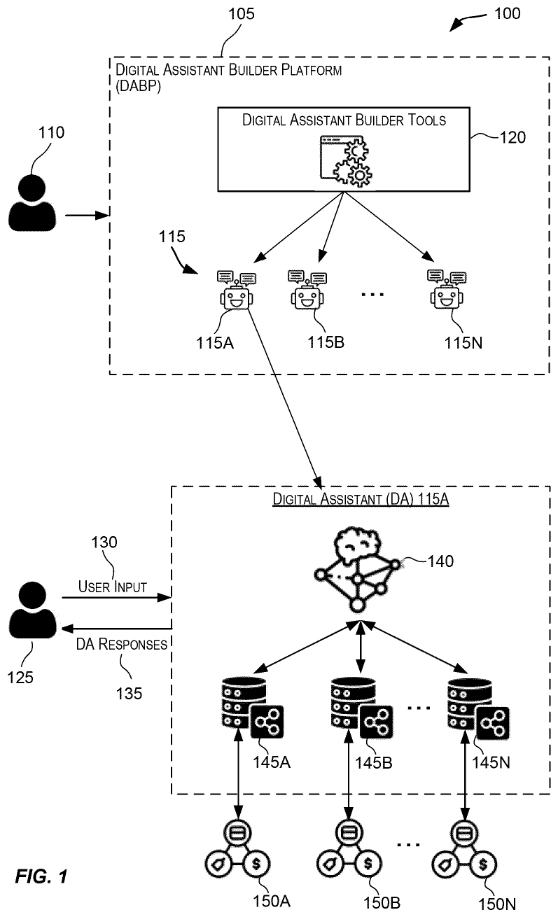

FIG. 1 is a simplified block diagram of an environment 100 incorporating a digital assistant system according to certain embodiments. Environment 100 includes a digital assistant builder platform (DABP) 105 that enables users 110 to create and deploy digital assistant systems 115. For purposes of this disclosure, a digital assistant is an entity that helps users of the digital assistant accomplish various tasks through natural language conversations. The DABP and digital assistant can be implemented using software only (e.g., the digital assistant is a digital entity implemented using programs, code, or instructions executable by one or more processors), using hardware, or using a combination of hardware and software. In some instances, the environment 100 is part of an Infrastructure as a Service (IaaS) cloud service (as described below in detail) and the DABP and digital assistant can be implemented as part of the IaaS by leveraging the scalable computing resources and storage capabilities provided by the IaaS provider to process and manage large volumes of data and complex computations. This setup allows the DABP and digital assistant to deliver real-time, responsive interactions while ensuring high availability, security, and performance scalability to meet varying demand levels. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

DABP 105 can be used to create one or more digital assistants (or DAs) systems. For example, as illustrated in FIG. 1, user 110 representing a particular enterprise can use DABP 105 to create and deploy a digital assistant 115A for users of the particular enterprise. For example, DABP 105 can be used by a bank to create one or more digital assistants for use by the bank's customers, for example to change a 401k contribution, etc. The same DABP 105 platform can be used by multiple enterprises to create digital assistants. As another example, an owner of a restaurant, such as a pizza shop, may use DABP 105 to create and deploy digital assistant 115B that enables customers of the restaurant to order food (e.g., order pizza).

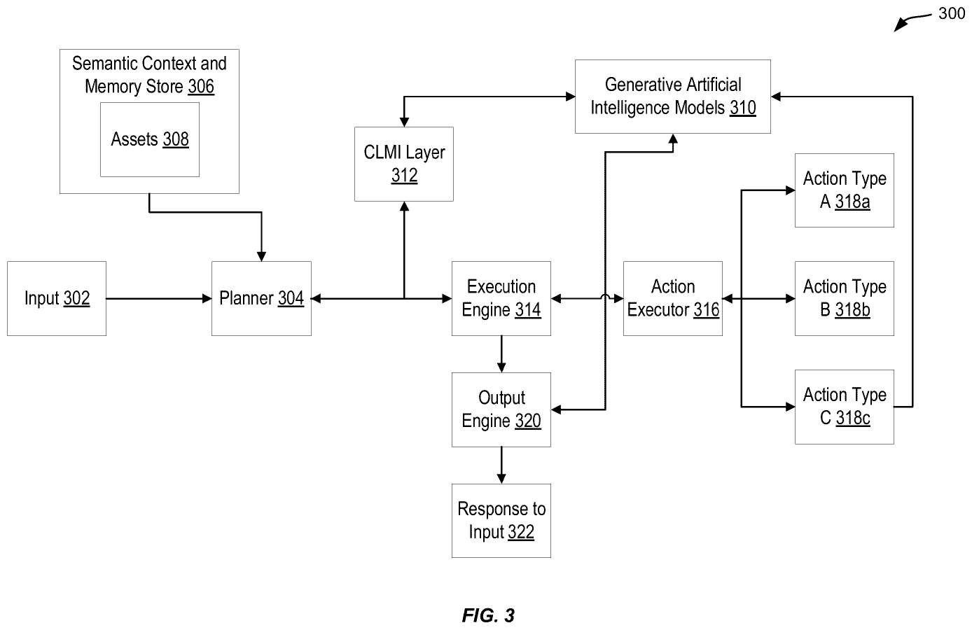

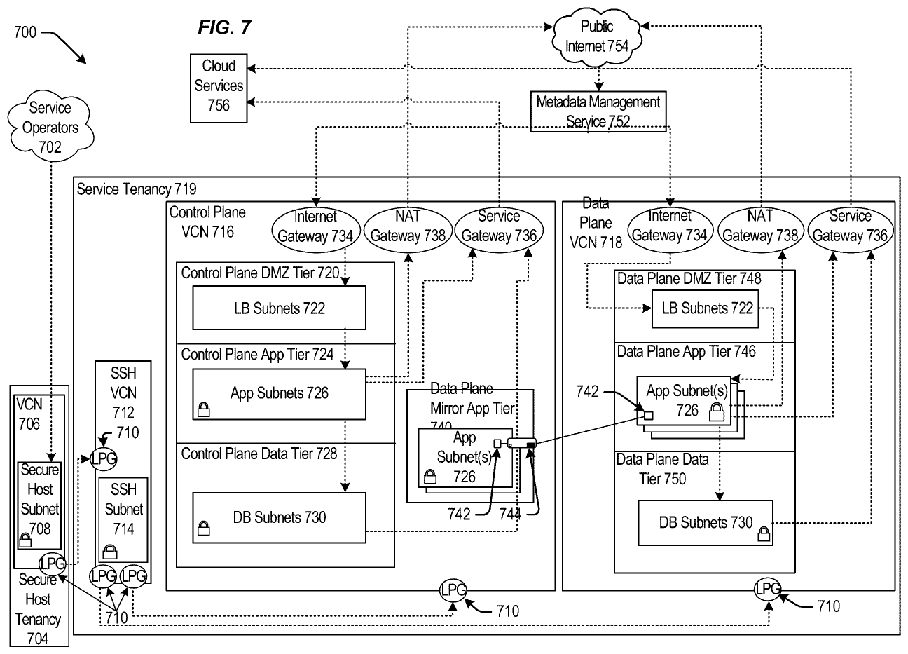

To create one or more digital assistant systems 115, the DABP 105 is equipped with a suite of tools 120, enabling the acquisition of LLMs, agent creation, asset identification, and deployment of digital assistant systems within a service architecture (described herein in detail with respect to FIG. 3) for users via a computing platform such as a cloud computing platform described in detail with respect to FIGS. 7-11. In some instances, the tools 120 can be utilized to access pre-trained and/or fine-tuned LLMs from data repositories or computing systems. The pre-trained LLMs serve as foundational elements, possessing extensive language understanding derived from vast datasets. This capability enables the models to generate coherent responses across various topics, facilitating transfer learning. Pre-trained models offer cost-effectiveness and flexibility, which allows for scalable improvements and continuous pre-training with new data, often establishing benchmarks in Natural Language Processing (NLP) tasks. Conversely, fine-tuned models are specifically trained for tasks or industries (e.g., plan creation utilizing the LLM's in-context learning capability, knowledge or information retrieval on behalf of an agent, response generation for human-like conversation, etc.), enhancing their performance on specific applications and enabling efficient learning from smaller, specialized datasets. Fine-tuning provides advantages such as task specialization, data efficiency, quicker training times, model customization, and resource efficiency. In some embodiments, fine-tuning may be particularly advantageous for niche applications and ongoing enhancement.

In other instances, the tools 120 can be utilized to pre-train and/or fine-tune the LLMs. The tools 120, or any subset thereof, may be standalone or part of a machine-learning operationalization framework, inclusive of hardware components like processors (e.g., CPU, GPU, TPU, FPGA, or any combination), memory, and storage. This framework operates software or computer program instructions (e.g., TensorFlow, PyTorch, Keras, etc.) to execute arithmetic, logic, input/output commands for training, validating, and deploying machine-learning models in a production environment. In certain instances, the tools 120 implement the training, validating, and deploying of the models using a cloud platform such as Oracle Cloud Infrastructure (OCI). Leveraging a cloud platform can make machine-learning more accessible, flexible, and cost-effective, which can facilitate faster model development and deployment for developers.

The tools 120 further include a prompt-based agent composition unit for creating agents and their associated actions (e.g., a prompt such as Tell me a joke, implicit Change Contribution, and Get Contribution API calls) that an end-user can end up invoking. The agents (e.g., 401k Change Contribution Agent) may be primarily defined as a compilation of agent artifacts using natural language within the prompt-based agent composition unit. Users 110 can create functional agents quickly by providing agent artifact information, parameters, and configurations and by pointing to assets. The assets can be or include resources, such as APIs for interfacing with applications, files and/or documents for retrieving knowledge, data stores for interacting with data, and the like, available to the agents for the execution of actions. The assets are imported, and then the users 110 can use natural language again to provide additional API customizations for dialog and routing/reasoning. Most of what an agent does may involve executing actions. An action can be an explicit action that's authored using natural language (similar to creating agent artifacts—e.g., ‘What is the impact of XYZ on my 401k Contribution limit?’ action in the below ‘401k Contribution Agent’ figure) or an implicit action that is created when an asset is imported (automatically imported upon pointing to a given asset based on metadata and/or specifications associated with the asset—e.g., actions created for Change Contribution and Get Contribution API in the below ‘401k Contribution Agent’ figure). The design time user can easily create explicit actions. For example, the user can choose the ‘Rich Text’ action type (see Table 1 for a list of exemplary action types) and creates the name artifact ‘What is the impact of XYZ on my 401k Contribution limit?’ when the user learns that a new FAQ needs to be added, as it's not currently in the knowledge documents (assets) the agent references (thus was not implicitly added as an action).

TABLE 1

| | Action Type | Description |
|---|---|---|
| 1 | Prompt | The action is implemented using a prompt to an LLM. |
| 2 | Rich Text | The action is implemented using rich text. |
| | | The most common use case is FAQs. |
| 3 | Flow | The action is implemented using Visual Flow Designer |
| | | flow. May be used for complex cases where the |
| | | developer is not able to use the out-of-the-box |
| | | dialogue and dialog customizations. |

There are various ways in which the agents and assets can be associated or added to a digital assistant 115. In some instances, the agents can be developed by an enterprise and then added to a digital assistant using DABP 105. In other instances, the agents can be developed and created using DABP 105 and then added to a digital assistant created using DABP 105. In yet other instances, DABP 105 provides an online digital store (referred to as an “agent store”) that offers various pre-created agents directed to a wide range of tasks and actions. The agents offered through the agent store may also expose various cloud services. In order to add the agents to a digital assistant being generated using DABP 105, a user 110 of DABP 105 can access assets via tools 120, select specific assets for an agent, initiate a few mock chat conversations with the agent, and indicate that the agent is to be added to the digital assistant created using DABP 105.

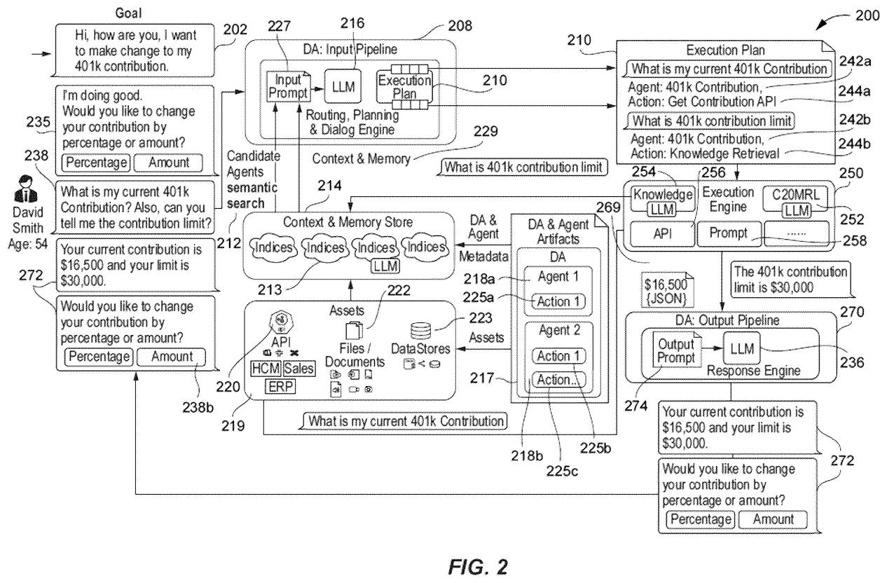

Once deployed in a production environment, such as the architecture described with respect to FIG. 2, a digital assistant, such as digital assistant 115A built using DABP 105, can be used to perform various tasks via natural language-based conversations between the digital assistant 115A and its users 125. As described above, the digital assistant 115A illustrated in FIG. 1, can be made available or accessible to its users 125 through a variety of different channels, such as but not limited to, via certain applications, via social media platforms, via various messaging services and applications, and other applications or channels. A single digital assistant can have several channels configured for it so that it can be run on and be accessed by different services simultaneously.

As part of a conversation, a user 125 may provide one or more user inputs 130 to digital assistant 115A and get responses 135 back from digital assistant 115A. A conversation can include one or more of user inputs 130 and responses 135. Via these conversations, a user 125 can request one or more tasks to be performed by the digital assistant 115A and, in response, the digital assistant 115A is configured to perform the user-requested tasks and respond with appropriate responses to the user 125 using one or more LLMs 140.

User inputs 130 are generally in a natural language form and are referred to as utterances, which may also be referred to as prompts, queries, requests, and the like. The user inputs 130 can be in text form, such as when a user types in a sentence, a question, a text fragment, or even a single word and provides it as input to digital assistant 115A. In some embodiments, a user input 130 can be in audio input or speech form, such as when a user says or speaks something that is provided as input to digital assistant 115A. The user inputs 130 are typically in a language spoken by the user 125. For example, the user inputs 130 may be in English, or some other language. When a user input 130 is in speech form, the speech input is converted to text form user input 130 in that particular language and the text utterances are then processed by digital assistant 115A. Various speech-to-text processing techniques may be used to convert a speech or audio input to a text utterance, which is then processed by digital assistant 115A. In some embodiments, the speech-to-text conversion may be done by digital assistant 115A itself. For purposes of this disclosure, it is assumed that the user inputs 130 are text utterances that have been provided directly by a user 125 of digital assistant 115A or are the results of conversion of input speech utterances to text form. This however is not intended to be limiting or restrictive in any manner.

The user inputs 130 can be used by the digital assistant 115A to determine a list of candidate agents 145A-N. The list of candidate agents (e.g., 145A-N) includes agents configured to perform one or more actions that could potentially facilitate a response 135 to the user input 130. The list may be determined by running a search, such as a semantic search, on a context and memory store that has one or more indices comprising metadata for all agents 145 available to the digital assistant 115A. Metadata for the candidate agents 145A-N in the list of candidate agents is then combined with the user input to construct an input prompt for the one or more LLMs 140.

Digital assistant 115A is configured to use one or more LLMs 140 to apply NLP techniques to text and/or speech to understand the input prompt and apply natural language understanding (NLU) including syntactic and semantic analysis of the text and/or speech to determine the meaning of the user inputs 130. Determining the meaning of the utterance may involve identifying the goal of the user, one or more intents of the user, the context surrounding various words or phrases or sentences, one or more entities corresponding to the utterance, and the like. The NLU processing can include parsing the received user inputs 130 to understand the structure and meaning of the utterance, refining and reforming the utterance to develop a better understandable form (e.g., logical form) or structure for the utterance. The NLU processing performed can include various NLP-related processing such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain instances, the NLU processing, or any portions thereof, is performed by the LLMs 140 themselves. In other instances, the LLMs 140 use other resources to perform portions of the NLU processing. For example, the syntax and structure of an input utterance sentence may be identified by processing the sentence using a parser, a part-of-speech tagger, a named entity recognition model, a pretrained language model such as BERT, or the like.

Upon understanding the meaning of an utterance, the one or more LLMs 140 generate an execution plan that identifies one or more agents (e.g., agent 145A) from the list of candidate agents to execute and perform one or more actions or operations responsive to the understood meaning or goal of the user. The one or more actions or operations are then executed by the digital assistant 115A on one or more assets (e.g., asset 150A-knowledge, API, SQL operations, etc.) and/or the context and memory store. The execution of the one or more actions or operations generates output data from one or more assets and/or relevant context and memory information from a context and memory store comprising context for a present conversation with the digital assistant 115A. The output data and relevant context and memory information are then combined with the user input 130 to construct an output prompt for one or more LLMs 140. The LLMs 140 synthesize the response 135 to the user input 130 based on the output data and relevant context and memory information, and the user input 130. The response 135 is then sent to the user 125 as an individual response or as part of a conversation with the user 125.

For example, a user input 130 may request a pizza to be ordered by providing an utterance such as “I want to order a pizza.” Upon receiving such an utterance, digital assistant 115A is configured to understand the meaning or goal of the utterance and take appropriate actions. The appropriate actions may involve, for example, providing responses 135 to the user with questions requesting user input on the type of pizza the user desires to order, the size of the pizza, any toppings for the pizza, and the like. The questions requesting user may be generated by executing an action via an agent (e.g., agent 145A) on a knowledge asset (e.g., a menu for a pizza restaurant) to retrieve information that is pertinent to ordering a pizza (e.g., to order a pizza a user must provide type, seize, topping, etc.). The responses 135 provided by digital assistant 115A may also be in natural language form and typically in the same language as the user input 130. As part of generating these responses 135, digital assistant 115A may perform natural language generation (NLG) using the one or more LLMs 140. For the user ordering a pizza, via the conversation between the user and digital assistant 115A, the digital assistant 115A may guide the user to provide all the requisite information for the pizza order, and then at the end of the conversation cause the pizza to be ordered. The ordering may be performed by executing an action via an agent (e.g., agent 145A) on an API asset (e.g., an API for ordering pizza) to upload or provide the pizza order to the ordering system of the restaurant. Digital assistant 115A may end the conversation by generating a final response 135 providing information to the user 125 indicating that the pizza has been ordered.

While the various examples provided in this disclosure describe and/or illustrate utterances in the English language, this is meant only as an example. In certain embodiments, digital assistants 115 are also capable of handling utterances in languages other than English. Digital assistants 115 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

While the embodiment in FIG. 1 illustrates the digital assistant 115A including one or more LLMs 140 and one or more agents 145A-N, this is not intended to be limiting. A digital assistant can include various other components (e.g., other systems and subsystems as described in greater detail with respect to FIG. 2) that provide the functionalities of the digital assistant. The digital assistant 115A and its systems and subsystems may be implemented only in software (e.g., code, instructions stored on a computer-readable medium and executable by one or more processors), in hardware only, or in implementations that use a combination of software and hardware.

FIG. 2 is an example of an architecture for a computing environment 200 for a digital assistant implemented with generative artificial intelligence in accordance with various embodiments. As illustrated in FIG. 2, an infrastructure and various services and features can be used to enable a user to interact with a digital assistant (e.g., digital assistant 115A described with respect to FIG. 1) based at least in part on a series of prompts such as a conversation. The following is a detailed walkthrough of a conversation flow and the role and responsibility of the components, services, models, and the like of the computing environment 200 within the conversation flow. In this walkthrough, it is assumed that a user “David” is interested in making a change to his 401k contribution, and in an utterance 202, David provides the following input to the digital assistant: Hi, how are you, I want to make a change to my 401k contribution.

The utterance 202 can be communicated to the digital assistant (e.g., via text dialogue box or microphone) and provided as input to the input pipeline 208. The input pipeline 208 is used by the digital assistant to create an execution plan 210 that identifies one or more agents to address the request in the utterance 202 and one or more actions for the one or more agents to execute for responding to the request. A two-step approach can be taken via the input pipeline 208 to generate the execution plan 210. First, a search 212 can be performed to identify a list of candidate agents. The search 212 comprises running a query on indices 213 of a context and memory store 214 based on the utterance 202. In some instances, the search 212 is a semantic search performed using words from the utterance 202, The semantic search uses NLP and optionally machine learning techniques to understand the meaning of the utterance 202 and retrieve relevant information from the context and memory store 214. In contrast to traditional keyword-based searches, which rely on exact matches between the words in the query and the data in the context and memory store 214, a semantic search takes into account the relationships between words, the context of the query, synonyms, and other linguistic nuances. This allows the digital assistant to provide more accurate and contextually relevant results, making it more effective in understanding the user's intent in the utterance 202.

The context and memory store 214 is implemented using a data framework for connecting external data to LLMs 216 to make it easy for users to plug in custom data sources. The data framework provides rich and efficient retrieval mechanisms over data from various sources such as files, documents, datastores, APIs, and the like. The data can be external (e.g., enterprise assets) and/or internal (e.g., user preferences, memory, digital assistant, and agent metadata, etc.). In some instances, the data comprises metadata extracted from artifacts 217 associated with the digital assistant and its agents 218 (e.g., 218a and 218b). The artifacts 217 for the digital assistant include information on the general capabilities of the digital assistant and specific information concerning the capabilities of each of the agents 218 (e.g., actions) available to the digital assistant (e.g., agent artifacts). Additionally or alternatively, the artifacts 217 can encompass parameters or information associated with the artifacts 217 and that can be used to define the agents 218 in which the parameters or information associated with the artifacts 217 can include a name, a description, one or more actions, one or more assets, one or more customizations, etc. In some instances, the data further includes metadata extracted from assets 219 associated with the digital assistant and its agents 218 (e.g., 218a and 218b). The assets 219 may be resources, such as APIs 220, files and/or documents 222, data stores 223, and the like, available to the agents 218 for the execution of actions (e.g., actions 225a, 225b, and 225c). The data is indexed in the context and memory store 214 as indices 213, which are data structures that provide a fast and efficient way to look up and retrieve specific data records within the data. Consequently, the context and memory store 214 provides a searchable comprehensive record of the capabilities of all agents and associated assets that are available to the digital assistant for responding to the request.

The results of the search 212 include a list of candidate agents that are not just available to the digital assistant for responding to the request but also potentially capable of facilitating the generation of a response to the utterance 202. The list of candidate agents includes the metadata (e.g., metadata extracted from artifacts 217 and assets 219) from the context and memory store 214 that is associated with each of the candidate agents. The list can be limited to a predetermined number of candidate agents (e.g., top 10) that satisfy the query or can include all agents that satisfy the query. The list of candidate agents with associated metadata is appended to the utterance 202 to construct an input prompt 227 for the LLM 216. In some instances, context 229 concerning the utterance 202 are additionally appended to the list of candidate agents and the utterance 202. The context 229 is retrievable from the context and memory store 214 and includes user session information, dialog state, conversation or contextual history, user information, or any combination thereof. The search 212 is important to the digital assistant because it filters out agents that are unlikely to be capable of facilitating the generation of a response to the utterance 202. This filter ensures that the number of tokens (e.g., word tokens) generated from the input prompt 227 remains under a maximum token limit or context limit set for the LLM 216. Token limits represent the maximum amount of text that can be inputted into an LLM. This limit is of a technical nature and arises due to computational constraints, such as memory and processing resources, and thus makes certain that the LLMs are capable of taking the input prompt as input.

The second step of the two-step approach is for the LLM 216 to generate an execution plan 210 based on the input prompt 227. The LLM 216 has a deep generative model architecture (e.g., a reversible or autoregressive architecture with) for generating the execution plan 210. In some instances, the LLM 216 has over 100 billion parameters and generates the execution plan 210 using autoregressive language modeling within a transformer architecture, allowing the LLM 216 to capture complex patterns and dependencies in the input prompt 227. The LLM's 216 ability to generate the execution plan 210 is a result of its training on diverse and extensive textual data, enabling the LLM to understand human language across a wide range of contexts. During training, the LLM 216 learns to predict the next word in a sequence given the context of the preceding words. This process involves adjusting the model's parameters (weights and biases) based on the errors between its predictions and the actual next words in the training data. When the LLM 216 receives an input such as the input prompt 227, the LLM 216 tokenizes the text into smaller units such as words or sub-words. Each token is then represented as a vector in a high-dimensional space. The LLM 216 processes the input sequence token by token, maintaining an internal representation of context. The LLM's 216 attention mechanism allows it to weigh the importance of different tokens in the context of generating the next word. For each token in the vocabulary, the LLM 216 calculates a probability distribution based on its learned parameters. This probability distribution represents the likelihood of each token being the next word given the context. To generate the execution plan 210, the LLM 216 samples a token from the calculated probability distribution. The sampled token becomes the next word in the generated sequence. This process is repeated iteratively, with each newly generated token influencing the context for generating the subsequent token. The LLM 216 can continue generating tokens until a predefined length or stopping condition is reached.

In some instances, as illustrated in FIG. 2, the LLM 216 may not be able to generate a complete execution plan 210 because it is missing information such as if more information is required to determine an appropriate agent for the response, execute one or more actions, or the like. In this particular instance, the LLM 216 has determine that in order to change the 401k contribution as request by the user, it is necessary to understand whether the user would like to change the contribution by a percentage or certain currency amount. In order to obtain this information, the LLM 216 (or another LLM such as LLM 236) generates end-user response 235 (I'm doing good. Would you like to change your contribution by percentage or amount? [Percentage] [Amount]) to the input prompt 227 that can obtain the missing information such that the LLM 216 is able to generate a complete execution plan 210. In some instances, the response may be rendered within a dialogue box of a GUI having one or more GUI elements allowing for an easier response by the user. In other instances, the response may be rendered within a dialogue box of a GUI allowing for the user to reply using the dialogue box (or alternative means such as a microphone). In this particular instance, the user responds with an additional query 238 (What is my current 401k Contribution? Also, can you tell me the contribution limit?) to gather additional information such that the user can reply to the response 235. The subsequent response-additional query 238—is input into the input pipeline 208 and the same processes described above with respect to utterance 202 are executed but this time with the context of the prior utterances/replies (e.g., utterance 202 and response 235) from the user's conversation with the digital assistant. This time, as illustrated in FIG. 2, the LLM 216 is able to generate a complete execution plan 210 because it has all the information it needs.

The execution plan 210 includes an ordered list of agents and/or actions that can be used and/or executed to sufficiently respond to the request such as the additional query 238. For example, and as illustrated in FIG. 2, the execution plan 210 can be an ordered list that includes a first agent 242a capable of executing a first action 244a via an associated asset and a second agent 242b capable of executing a second action 244b via an associated asset. The agents, and by extension the actions, may be ordered to cause the first action 244a to be executed by the first agent 242a prior to causing the second action 244b to be executed by the second agent 242b. In some instances, the execution plan 210 may be ordered based on dependencies indicated by the agents and/or actions included in the execution plan 210. For example, if executing the second agent 242b is dependent on, or otherwise requires, an output generated by the first agent 242a executing the first action 244a, then the execution plan 210 may order the first agent 242a and the second agent 242b to comply with the dependency. As should be understood, other examples of dependencies are possible.

The execution plan 210 is then transmitted to an execution engine 250 for implementation. The execution engine 250 includes a number of engines, including a natural language-to-programming language translator 252, a knowledge engine 254, an API engine 256, a prompt engine 258, and the like, for executing the actions of agents and implementing the execution plan 210. For example, the natural language-to-programming language translator 252, such as a Conversation to Oracle Meaning Representation Language (C20MRL) model, may be used by an agent to translate natural language into a intermedial logical for (e.g., OMRL), convert the intermediate logical form into a system programming language (e.g., SQL) and execute the system programming language (e.g., execute an SQL query) on an asset 219 such as data stores 223 to execute actions and/or obtain data or information. The knowledge engine 254 may be used by an agent to obtain data or information from the context and memory store 214 or an asset 219 such as files/documents 222. The API engine 256 may be used by an agent to call an API 220 and interface with an application such as retirement fund account management application to execute actions and/or obtain data or information. The prompt engine 258 may be used by an agent to construct a prompt for input into an LLM such as an LLM in the context and memory store 214 or an asset 219 to execute actions and/or obtain data or information.

The execution engine 250 implements the execution plan 210 by running each agent and executing each action in order based on the ordered list of agents and/or actions using the appropriate engine(s). To facilitate this implementation, the execution engine 250 is communicatively connected (e.g., via a public and/or provue network) with the agents (e.g., 242a, 242b, etc.), the context and memory store 214, and the assets 219. For example, as illustrated in FIG. 2, when the execution engine 250 implements the execution plan 210, it will first execute the agent 242a and action 244a using API engine 256 to call the API 220 and interface with a retirement fund account management application to retrieve the user's current 401k contribution. Subsequently, the execution engine 250 can execute the agent 242b and action 244b using knowledge engine 254 to retrieve knowledge on 401k contribution limits. In some instances, the knowledge is retrieved by knowledge engine 254 from the assets 219 (e.g., files/documents 222). In other instances (as in this particular instance), the knowledge is retrieved by knowledge engine 254 from the context and memory store 214. Knowledge retrieval and action execution using the context and memory store 214 may be implemented using various techniques including internal task mapping and/or machine learning models such as additional LLM models. For example, the query and associated agent for “What is 401k contribution limit” may be mapped to a ‘semantic search’ knowledge task type for searching the indices 213 within the context and memory store 214 for a response to a given query. By way of another example, a request such as “Can you summarize the key points relating to 401k contribution” can be or include a ‘summary’ knowledge task type that may be mapped to a different index within the context and memory store 214 having an LLM trained to create a natural language response (e.g., summary of key points relating to 401k contribution) to a given query. Over time, a library of generic end-user task or action types (e.g., semantic search, summarization, compare/contrast, heterogeneous data synthesis, etc.) may be built to ensure that the indices and models within the context and memory store 214 are optimized to the various task or action types.

The result of implementing the execution plan 210 is output data 269 (e.g., results of actions, data, information, etc.), which is transmitted to an output pipeline 270 for generating end-user responses 272. For example, the output data 269 from the assets 219 (knowledge, API, dialog history, etc.) and relevant information from the context and memory store 214 can be transmitted to the output pipeline 270. The output data 269 is appended to the utterance 202 to construct an output prompt 274 for input to the LLM 236. In some instances, context 229 concerning the utterance 202 are additionally appended to the output data 269 and the utterance 202. The context 229 is retrievable from the context and memory store 214 and includes user session information, dialog state, conversation or contextual history, user information, or any combination thereof. The LLM 236 generates responses 272 based on the output prompt 274. In some instances, the LLM 236 is the same or similar model as LLM 216. In other instances, the LLM 236 different from LLM 216 (e.g., trained on a different set of data, a different architecture, trained for a one or more different tasks, etc.). In either instance, the LLM 236 has a deep generative model architecture (e.g., a reversible or autoregressive architecture with) for generating the responses 272 using similar training and generative processes described above with respect to LLM 216. In some instances, the LLM 236 has over 100 billion parameters and generates the responses 272 using autoregressive language modeling within a transformer architecture, allowing the LLM 236 to capture complex patterns and dependencies in the output prompt 274.

In some instances, the end-user responses 272 may be in the format of a Conversation Message Model (CMM) and output as rich multi-modal responses. The CMM defines the various message types that the digital assistant can send to the user (outbound), and the user can send to the digital assistant (inbound). In certain instances, the CMM identifies the following message types:
text: Basic text message
card: A card representation that contains a title and, optionally, a description, image, and link
attachment: A message with a media URL (file, image, video, or audio)
location: A message with geo-location coordinates
postback: A message with a postback payload
   Messages that are defined in CMM are channel-agnostic and can be created using CMM syntax. The channel-specific connectors transform the CMM message into the format required by the specific channel, allowing a user to run the digital assistant on multiple channels without the need to create separate message formats for each channel.

Lastly, the output pipeline 270 transmits the responses 272 to the end user such as via a user device or interface. In some instances, the responses 272 are rendered within a dialogue box of a GUI allowing for the user to view and reply using the dialogue box (or alternative means such as a microphone). In other instances, the responses 272 are rendered within a dialogue box of a GUI having one or more GUI elements allowing for an easier response by the user. In this particular instance, a first response 272 (What is my current 401k Contribution? Also, can you tell me the contribution limit?) to the additional query 238 is rendered within the dialogue box of a GUI. Additionally, in order to follow-up on obtaining information still required for the initial utterance 202, the LLM 236 generates another response 272 prompting the user for the missing information (Would you like to change your contribution by percentage or amount? [Percentage] [Amount]).

While the embodiment of computing environment 200 in FIG. 2 illustrates the digital assistant interacting in a particular conversation flow, this is not intended to be limiting and is merely provided to facilitate a better understanding of the role and responsibility of the components, services, models, and the like of the computing environment 200 within the conversation flow.

### Block Diagrams for Computing Environments Including a Digital Assistant

FIG. 3 is a simplified block diagram of a computing environment including a digital assistant 300 that can execute an execution plan for responding to an utterance from a user in accordance with various embodiments. In some embodiments, the utterance may be provided from the user to the digital assistant 300 via input 302. The input 302 may be or include natural language utterances that can include text input, voice input, image input, or any other suitable input for the digital assistant 300. For example, the input 302 may include text input provided by the user via a keyboard or touchscreen of a computing device used by the user. In other examples, the input 302 may include spoken words provided by the user via a microphone of the computing device. In other examples, the input 302 may include image data, video data, or other media provided by the user via the computing device. Additionally or alternatively, the input 302 may include indications of actions to be performed by the digital assistant 300 on behalf of the user. For example, the input 302 may include an indication that the user wants to order a pizza, that the user wants to update a retirement account contribution, or other suitable indications.

The input 302 may be provided to a planner 304 of the digital assistant 300. The planner 304 may generate an execution plan based on the input 302 and based on context provided to the planner 304. The planner 304 may receive the input 302 and may make a call to a semantic context and memory store 306 to retrieve the context. In some embodiments, the semantic context and memory store 306 includes one or more assets 308, which may be similar or identical to the assets 219. The planner 304 may provide at least a portion of the input 302 to the semantic context and memory store 306, which can perform a semantic search on the assets 308 and/or other knowledge included in the semantic context and memory store 306. The semantic search may generate a list of candidate actions, from among all actions that can be performed via one or more of the assets 308, that may be used to address the input 302 or any subset thereof. In some embodiments, the candidate actions may be generated only based on contextual information. For example, the input 302 may be compared with metadata of the actions to generate the candidate actions.

The planner 304 may use the candidate actions to form an input prompt for a generative artificial intelligence model. The generative artificial intelligence model may be or be included in generative artificial intelligence models 310, which may include one or more large language models (LLMs). The planner 304 may be communicatively coupled with the generative artificial intelligence models 310 via a common language model interface layer (CLMI layer 312). The CLMI layer 312 may be an adapter layer that can allow the planner 304 to call a variety of different generative artificial intelligence models that may be included in the generative artificial intelligence models 310. For example, the planner 304 may generate an input prompt and may provide the input prompt to the CLMI layer 312 that can convert the input prompt into a model-specific input prompt for being input into a particular generative artificial intelligence model. The planner 304 may receive output from the particular generative artificial intelligence model that can be used to generate an execution plan. The output may be or include the execution plan. In other embodiments, the output may be used as input by the planner 304 to allow the planner 304 to generate the execution plan. The output may include a list that includes one or more executable actions based on the utterance included in the input 302. In some embodiments, the execution plan may include an ordered list of actions to execute for addressing the input 302.

The planner 304 can transmit the execution plan to the execution engine 314 for executing the execution plan. The execution engine 314 may perform an iterative process for each executable action included in the execution plan. For example, the execution engine 314 may, for each executable action, identify an action type, may invoke one or more states for executing the action type, and may execute the executable action using an asset to obtain an output. The execution engine 314 may be communicatively coupled with an action executor 316 that may be configured to perform at least a portion of the iterative process. For example, the action executor 316 can identify one or more action types for each executable action included in the execution plan. In a particular example, the action executor 316 may identify a first action type 318a for a first executable action of the execution plan. The first action type 318a may be or include a semantic action such as summarizing text or other suitable semantic action.

Additionally or alternatively, the action executor 316 may identify a second action type 318b for a second executable action of the execution plan. The second action type 318b may involve invoking an API such as an API for making an adjustment to an account or other suitable API. Additionally or alternatively, the action executor 316 may identify a third action type 318c for a third executable action of the execution plan. The third action type 318c may be or include a knowledge action such as providing an answer to a technical question or other suitable knowledge action. In some embodiments, the third action type 318c may involve making a call to at least one generative artificial intelligence model of the generative artificial intelligence models 310 to retrieve specific knowledge or a specific answer. In other embodiments, the third action type 318c may involve making a call to the semantic context and memory store 306 or other knowledge documents.

The action executor 316 may continue the iterative process based on the action types indicated by the executable actions included in the execution plan. Once the action executor 316 identifies the action types, the action executor 316 may identify and/or invoke one or more states for each executable action based on the action type. A state of an action may involve an indication of if or whether an action can be or has been executed. For example, the state for a particular executable action may include “preparing” “ready” “executing” “success” “failure” or any other suitable states. The action executor 316 can determine, based on the invoked state of the executable action, whether the executable action is ready to be executed, and, if the executable action is not ready to be execute, the action executor 316 can identify missing information or assets required for proceeding with executing the executable action. In response to determining that the executable action is ready to be executed, and in response to determining that no dependencies exist (or existing dependencies are satisfied) for the executable action, the action executor 316 can execute the executable action to generate an output.

The action executor 316 can execute each executable action, or any subset thereof, included in the execution plan to generate a set of outputs. The set of outputs may include knowledge outputs, semantic outputs, API outputs, and other suitable outputs. The action executor 316 may provide the set of outputs to an output engine 320. The output engine 320 may be configured to generate a second input prompt based on the set of outputs. The second input prompt can be provided to at least one generative artificial intelligence model of the generative artificial intelligence models 310 to generate a response 322 to the input 302. The output engine 320 may make a call to the at least one generative artificial intelligence model to cause the at least one generative artificial intelligence model to generate the response 322, which can be provided to the user in response to the input 302. In some embodiments, the at least one generative artificial intelligence model used to generate the response 322 may be similar or identical to, or otherwise the same model, as the at least one generative artificial intelligence model used to generate output for generating the execution plan.

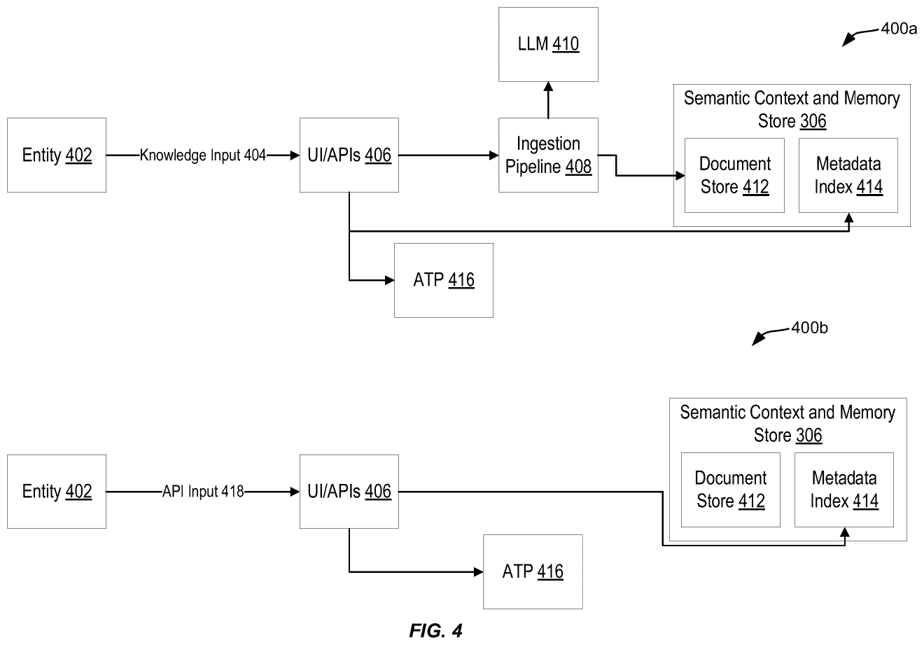

FIG. 4 is a simplified block diagram illustrating data flows for updating a semantic context and memory store 306 for a digital assistant 300 that can execute an execution plan for responding to an utterance from a user in accordance with various embodiments. As illustrated in FIG. 4, an entity 402 can provide different types of input for updating the semantic context and memory store 306. A first data flow 400a illustrates knowledge updates for the semantic context and memory store 306, and a second data flow 400b illustrates API updates for the semantic context and memory store 306.

As illustrated in the first data flow 400a, the entity 402 can provide knowledge input 404 for updating the semantic context and memory store 306. The entity 402 may provide the knowledge input 404 via a computing device that is configured to provide a UI/API 406. The UI/API 406 may be or include a user interface that can be used to manage APIs with respect to the digital assistant 300 or to otherwise manage updates to the semantic context and memory store 306. The knowledge input 404 may include updates to rules, additional information that can be provided to users, and any other suitable knowledge inputs. The UI/API 406 can receive the knowledge input 404 and can provide the knowledge input 404, or a converted version thereof, to an ingestion pipeline 408. The ingestion pipeline 408 can be communicatively coupled with one or more LLMs 410, which may be similar or identical to one or more generative artificial intelligence models included in the generative artificial intelligence models 310. The ingestion pipeline 408 may generate an input prompt based on the knowledge input 404 that can be provided to the one or more LLMs 410 for generating output. In some embodiments, the one or more LLMs 410 may be configured to generate output based on the input prompt in which the output can be or include content, based on the knowledge input 404, that can be stored at the semantic context and memory store 306. The content may include the substance of the knowledge input 404 in a concise form and compatible format for storing at the semantic context and memory store 306. Additionally or alternatively, the one or more LLMs 410 can generate a summary of the knowledge input 404, and the summary can be provided to the UI/API 406.

The content and an index based on the summary can be stored at the semantic context and memory store 306. The semantic context and memory store 306 can include a document store 412, a metadata index 414, and any other suitable data repositories and/or indices. The content generated by the one or more LLMs 410 can be transmitted by the ingestion pipeline 408 to the document store 412 to be stored, and the UI/API 406 can transmit the index to the metadata index 414 to be stored. The content may be accessible, such as via a search of the index, to the digital assistant 300 for responding to future inputs relevant to the knowledge input 404. Additionally or alternatively, the UI/API 406 may transmit the summary to ATP 416. The ATP 416 may be or include a data repository that can store descriptions of assets and knowledge stored at the semantic context and memory store 306.

As illustrated in the second data flow 400b, the entity 402 can provide API input 418 for updating the semantic context and memory store 306. The entity 402 may provide the API input 418 via a computing device that is configured to provide the UI/API 406. The UI/API 406 may be or include a user interface that can be used to manage APIs with respect to the digital assistant 300 or to otherwise manage updates to the semantic context and memory store 306. The API input 418 may include an additional asset involving an API or may otherwise include an update to APIs that can be invoked by the digital assistant 300. For example, the API input 418 may include instructions for allowing the digital assistant 300 to make a new API call involving a new asset. In a particular example, the API input 418 may indicate a new API for updating a new type of account by the digital assistant 300. The UI/API 406 can store an artifact or a semantic object model associated with the API input 418 at the ATP 416. Additionally or alternatively, the UI/API 406 can generate or identify metadata based on the API input 418, and the UI-API 406 can transmit an index involving the metadata to the metadata index 414 of the semantic context and memory store 306.

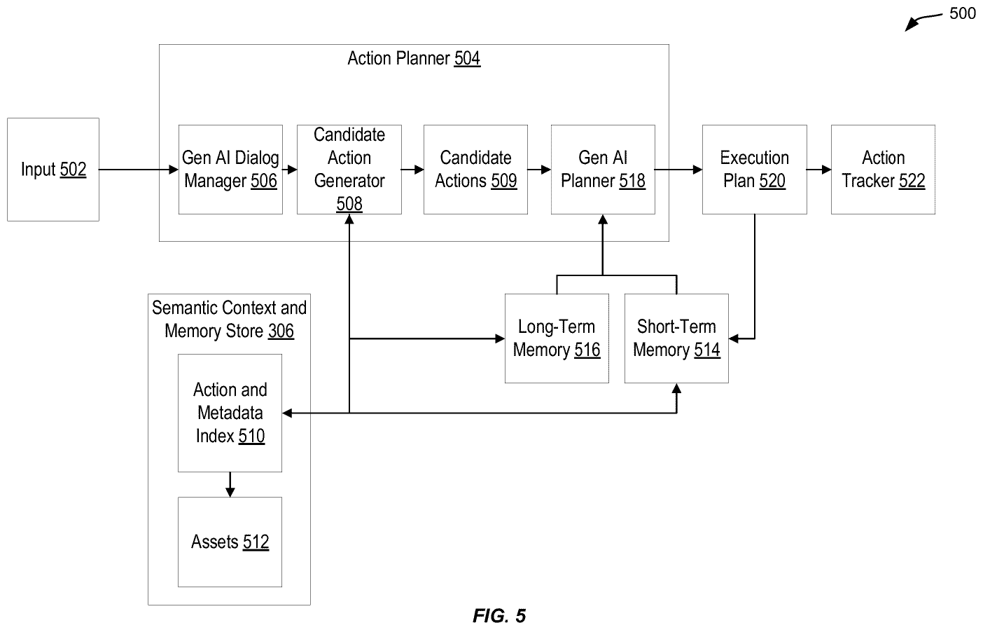

FIG. 5 is a simplified block diagram of an example of a data flow for planning a response to an utterance from a user using a digital assistant 300 that can execute an execution plan in accordance with various embodiments. As illustrated in FIG. 5, input 502 can be received, for example from a user of the digital assistant 300. In some embodiments, the input 502 may be or include natural language such as natural language text, natural language audio, or other suitable forms of natural language. The input 502 can be received by an action planner 504 such as via a generative artificial intelligence dialog manager 506. The generative artificial intelligence dialog manager 506 may be or include an LLM-based dialog manager that can be an entry point for input from users and that can detect existing actions, can re-write queries, and can run fulfillment of actions. For example, if the generative artificial intelligence dialog manager 506 determines that no actions are presently being execute or scheduled to be executed, then the generative artificial intelligence dialog manager 506 can provide the input 502, or any subset or variation thereof, to a candidate action generator 508.

The candidate action generator 508 can perform, or cause to be performed, a semantic search based on the input 502, or any subset or variation thereof. For example, the candidate action generator 508 may generate and transmit a query to the semantic context and memory store 306 to cause the semantic context and memory store 306 to parse one or more indices to identify candidate actions 509 based on the input 502, etc. The query may involve parsing and/or searching through an action and metadata index 510 to identify the candidate actions 509. In some embodiments, the semantic search may involve searching among assets 512 to identify the candidate actions 509. For example, the query may include tasks indicated by the input 502 and may cause the semantic context and memory store 306 to compare the indicated tasks to metadata about the assets 512 to identify candidate actions 509 using only context such as the metadata about the assets 512. In a particular example, the query can include tasks, such as updating an account balance, and the semantic search can involve searching the assets 512 for a particular asset, such as an API asset, that has metadata indicating that the particular asset is capable of updating the account balance. In such an example, a result of the semantic search may include candidate actions 509 that include a particular action that can be performed by the particular asset.

The candidate actions 509 may also be influenced by data stored in short-term memory 514 and/or long-term memory 516. For example, historical access data may be retrieved by the candidate action generator 508 to use in determining the candidate actions 509. The historical access data may include historical data indicating actions selected previously by other users in response to other inputs provided by the other users. For example, if a particular action has historically been chosen a majority of the time in response to similar input, then the candidate action generator 508 may include the particular action in the candidate actions 509 regardless of whether the metadata associated with the particular action, or asset capable of performing the particular action, is similar to the input 502 or the query provided by the candidate action generator 508.

The candidate actions 509, which includes actions selected by the candidate action generator 508 based on historical access data and similarity between actions and the query provided to initiate the semantic search, can be provided to a generative artificial intelligence planner 518. The generative artificial intelligence planner 518 can receive the candidate actions 509 and can generate an execution plan 520 based on actions included in the candidate actions 509. For example, the generative artificial intelligence planner 518 can determine whether each action of the candidate actions 509, or any subset thereof, is available and can generate an ordered list of the available actions as the execution plan 520. In some embodiments, the generative artificial intelligence planner 518 can identify any dependencies that exist between actions included in the candidate actions 509 and can include the dependencies in the execution plan 520. In some embodiments, and for each executable action included in the candidate actions 509, the generative artificial intelligence planner 518 can create an artifact representing the executable action, and the artifact can include indications of any dependencies, whether the executable action is available or ready to be executed, what additional information, if any, is needed to convert the state of the executable action to ready to execute, and/or any other suitable indications.

The execution plan 520 can be provided to an execution engine, such as the execution engine 314, that can execute actions included in the execution plan 520. In some embodiments, the execution engine can sequentially execute actions included in the execution plan 520 that are indicated as ready to be executed. That is, the execution engine may execute actions included in the execution plan 520 that have invoked a ready to execute state, that do not have any dependencies (or that have all dependencies satisfied), etc. An action tracker 522 can track progress of executing the execution plan 520. For example, the action tracker 522 may determine whether actions have been executed, whether executed actions are successful or are failed, etc. The status of the actions included in the execution plan 520 can be saved and continuously updated or persisted in the short-term memory 514 for use in future or iterative uses of the generative artificial intelligence planner 518.

### Flowchart for Executing an Execution Plan

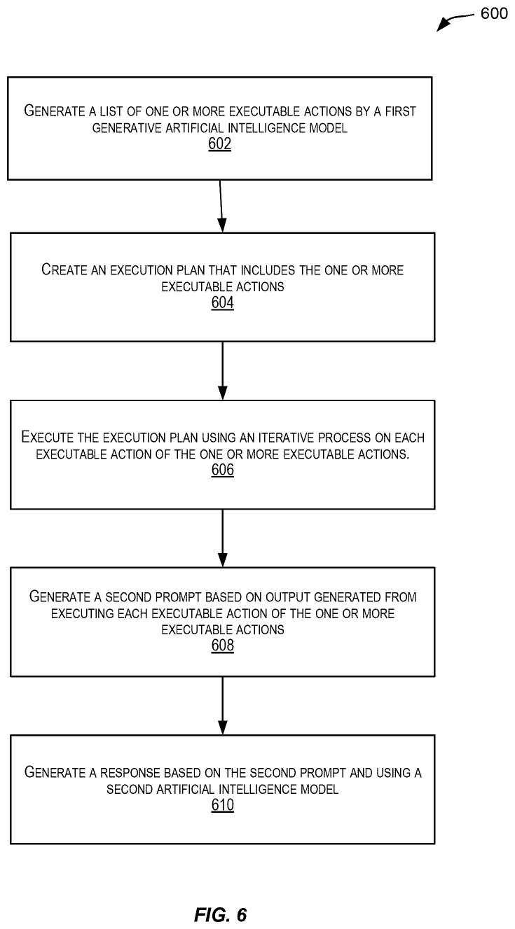

FIG. 6 is a flowchart of a process 600 for executing an execution plan using a digital assistant including generative artificial intelligence in accordance with various embodiments. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 6 and described below is intended to be illustrative and non-limiting. Although FIG. 6 illustrates the various processing steps occurring in a particular sequence or order, this is not intended to be limiting. In certain alternative embodiments, the steps may be performed in some different order or some steps may also be performed at least partially in parallel. In certain embodiments, the processing depicted in FIG. 6 may be performed by one or more of the components, computing devices, services, or the like, such as the digital assistant, the first and/or second generative artificial intelligence model (LLMs), etc., illustrated and described with respect to FIGS. 1-5.

At 602, a list that includes one or more executable actions is generated by a first generative artificial intelligence model. The list of one or more executable actions can be generated by the first generative artificial intelligence model based on a first prompt that includes a natural language utterance provided by a user of a digital assistant. In some examples, the first prompt may include the natural language utterance augmented with a separate prompt to cause the first generative artificial intelligence model to output the list that includes the one or more executable actions. The list that includes the one or more executable actions can include one or more executable actions, and each executable action may be associated with an asset that can be accessed or invoked by the digital assistant. An executable action can include an action that can be executed, such as by an execution engine 314, to perform a task indicated by the natural language utterance. In a particular example, a task can include providing information requested by the user, updating an account based on a user request to do so, etc. In some embodiments, the planner 304 may generate the first prompt and may transmit the first prompt to the first generative artificial intelligence model to cause the first generative artificial intelligence model to output the list that includes one or more executable actions. In some embodiments, generating the list of the one or more executable actions can include selecting the one or more executable actions from a list of candidate actions that are determined via a semantic search of a semantic index, which may be included in the semantic context and memory store 306.

At 604, an execution plan is created, and the execution plan includes the one or more executable actions. The execution plan, which may be similar or identical to the execution plan 520, can be or include an ordered list of the one or more executable actions. In some embodiments, creating the execution plan can involve performing an evaluation of the one or more executable actions. The evaluation may include evaluating the one or more executable actions based on one or more ongoing conversation paths, if any, initiated by the user. The evaluation may also include evaluating the one or more executable actions based on any currently active execution plans. Evaluating the one or more executable actions can involve determining whether similar actions, compared with the one or more executable actions, are scheduled to be executed, or have previously been executed, in the ongoing conversation paths or in the currently active execution plans.

In some embodiments, creating the execution plan can, in response to the evaluation determining that the natural language utterance is part on an ongoing conversation path, additionally include incorporating the one or more executable actions into a currently active execution plan associated with the ongoing conversation path. The currently active execution plan, after incorporation of the one or more executable actions, may be or include an ordered list of the one or more executable actions and one or more prior actions. In some embodiments, creating the execution plan can, in response to the evaluation determining that the natural language utterance is not part of an ongoing conversation path, additionally include creating a new execution plan that can be or include an ordered list of the one or more executable actions.

In some embodiments, creating the execution plan can additionally include identifying, based at least in part on metadata associated with candidate agent actions within a list of candidate agent actions, the one or more executable actions that provide information or knowledge for generating a response to the natural language utterance. Additionally or alternatively, creating the execution plan can additionally include generating a structured output for the execution plan by creating an ordered list of the one or more executable actions and a set of dependencies among the one or more executable actions.

At 606, the execution plan is executed using an iterative process for each executable action of the one or more executable actions. In some embodiments, the iterative process can include identifying an action type for an executable action, invoking one or more states configured to execute the action type, and executing, by the one or more states, the executable action using an asset to obtain an output. The action type may indicate a workflow, or an order or set of states to invoke, for the corresponding executable action. For example, if the corresponding executable action has a first action type, the digital assistant may use a first set of states to invoke as the workflow for executing the executable action, and if the corresponding executable action has a second action type, the digital assistant may use a second set of states to invoke as the workflow for executing the corresponding executable action in which the first set of states and the second set of states may be different from one another.

The one or more states can include an indication of whether a particular action is ready to be executed, needs more information or an additional asset to be executed, has been executed (e.g., successfully or unsuccessfully), is presently being executed, etc. For example, one or more states can be invoked to execute a particular action type. A first state may be invoked to identify whether the executable action having the particular action type has been executed to generate a response. If it is determined, in response to invoking the first state, that the executable action has been executed and a response has been generated, then the iterative process may proceed. If it is determined, in response to invoking the first state, that the executable action has not been executed or that a response has not been generated, then a second state may be invoked to determine whether one or more parameters are available for the executable action. If the one or more parameters are not available, the digital assistant may generate a response requesting the one or more parameters from the user. In other embodiments, if the one or more parameters are not available, the digital assistant may generate a prompt for causing a generative artificial intelligence model to identify or generate the one or more parameters.

The one or more states may be used to execute the executable action with an asset to obtain an output. For example, a third state, which may be different from the first state and/or the second state described above, may be invoked to generate the output. The third state may be an execution state that causes the digital assistant to make a call to, or otherwise initiate an operation using, the asset to cause generation of the output. In some embodiments, the output may be populated into a set of outputs provided to an output engine that can be used to generate a response. The set of outputs may include the outputs generated by executing each executable action included in the execution plan.

In some embodiments, the iterative process may additionally include determining whether one or more parameters are available for the executable action. A particular state may be invoked to identify the one or more parameters or to determine that the one or more parameters are not available. In embodiments, in which the one or more parameters are available, the iterative process can additionally include invoking the one or more states, as described above, and executing the executable action based on the one or more parameters. In examples in which the one or more parameters are not available, the iterative process may additionally include obtaining the one or more parameters that are not available and then invoking the one or more states and executing the executable action based on the one or more parameters. In some embodiments, obtaining the one or more parameters can include generating a natural language request to the user to obtain the one or more parameters for the executable action, and receiving a response from the user in which the response may include the one or more parameters. In some embodiments, the iterative process can additionally include determining that one or more dependencies exist between the executable action and at least one other executable action of the one or more executable actions based on the set of dependencies among the one or more executable actions. The executable action can be executed sequentially in accordance with the one or more dependencies determined to exist between the executable action and the at least one other executable action.

At 608, a second prompt is generated based on the output obtained from executing each of the one or more executable actions. The second prompt may be generated by the output engine, and the output engine can generate the second prompt based on the set of outputs. The second prompt may include each output of the set of outputs and may include augmented natural language or other input for causing a generative artificial intelligence model to generate a desired output.

At 610, a response to the natural language utterance based on the second prompt is generated by a second generative artificial intelligence model. In some embodiments, the second generative artificial intelligence model may be similar or identical to the first generative artificial intelligence model. In other embodiments, the second generative artificial intelligence model may be different from the first generative artificial intelligence model. The second prompt can be provided to the second generative artificial intelligence model to cause the second generative artificial intelligence model to generate the response. In some embodiments, the response may be or include natural language text, fields, links, or other suitable components for the response. The natural language text may be or include words, phrases, sentences, etc. that respond to the natural language utterance. In examples in which additional information may be requested from the user by the digital assistant, the response may include, along with the natural language text, fields for allowing the user to enter information, links to predefined responses or digital locations to find answers, etc. The digital assistant can transmit the response to a computing device associated with the user to present the response to the user, to request additional information from the user, etc.

### Examples of Architectures for Implementing Cloud Infrastructures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may need to be set up first. In some instances, the provisioning can be done manually, a provisioning tool may be utilized to provision the resources, and/or deployment tools may be utilized to deploy the code once the infrastructure is provisioned.

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

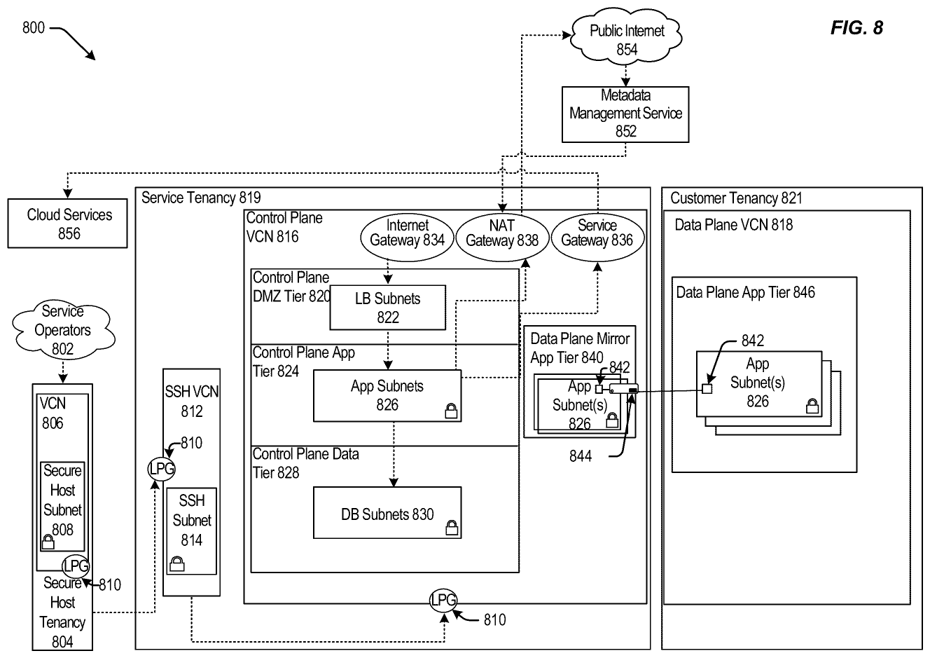

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 5,” may be located in Region 1 and in “Region 2.” If a call to Deployment 5 is made by the service gateway 836 contained in the control plane VCN 816 located in Region 1, the call may be transmitted to Deployment 5 in Region 1. In this example, the control plane VCN 816, or Deployment 5 in Region 1, may not be communicatively coupled to, or otherwise in communication with, Deployment 5 in Region 2.

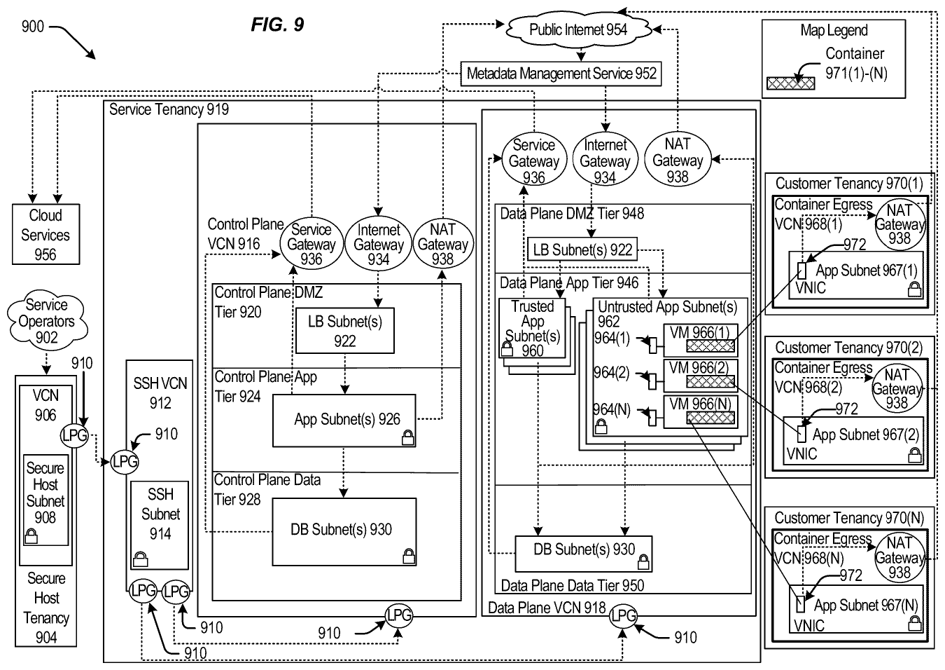

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

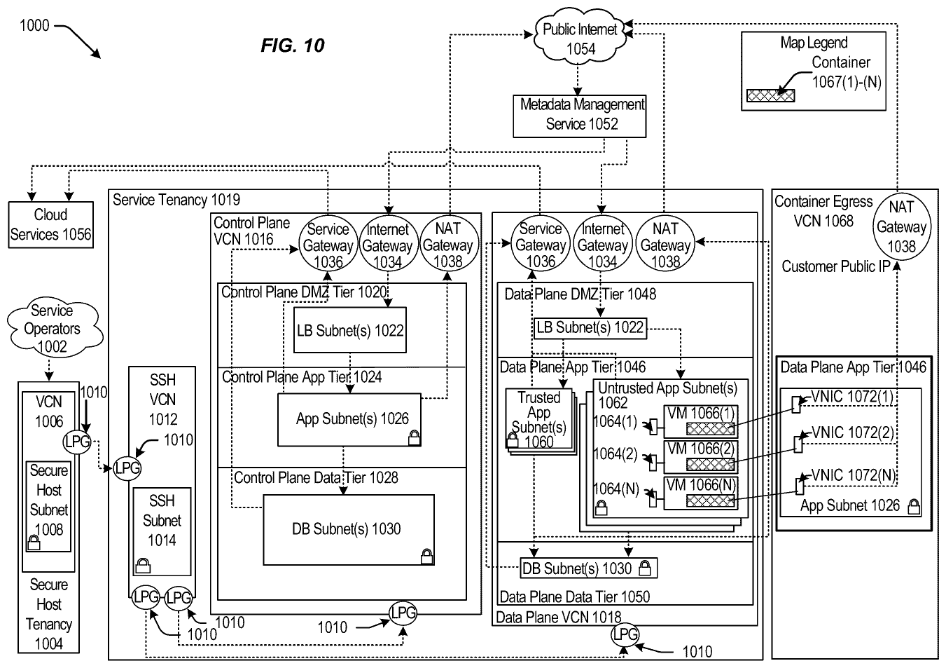

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

### Example of a Computer System or Device

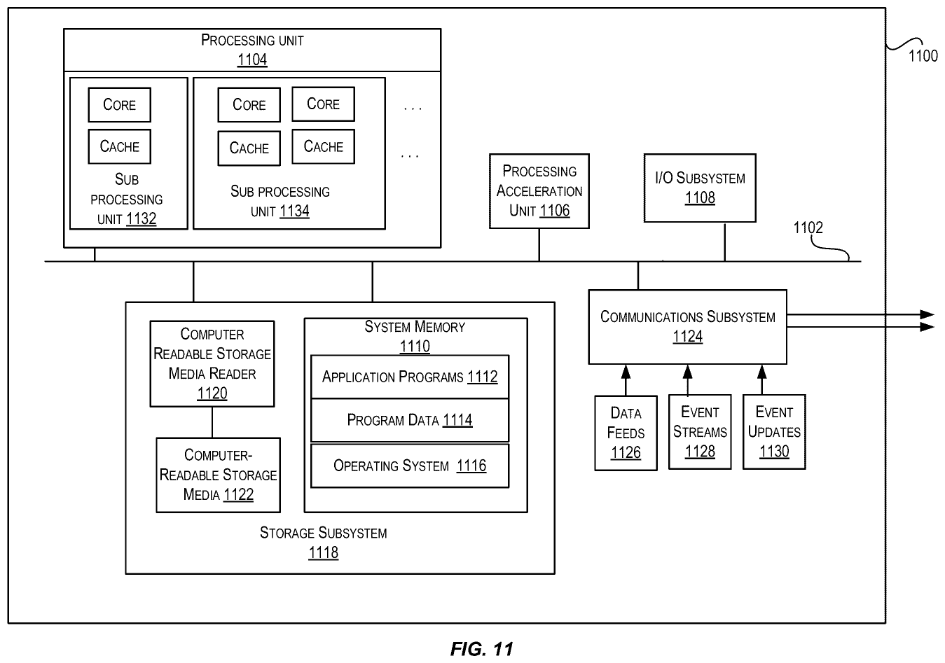

FIG. 11 illustrates an example computer system 1100, in which various embodiments may be implemented. The system 1100 may be used to implement any of the computer systems and processing systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some, or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments provides an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A computer-implemented method comprising:
generating, by a first generative artificial intelligence model, a list comprising one or more executable actions based on a first prompt comprising a natural language utterance provided by a user;
creating an execution plan comprising the one or more executable actions;
executing the execution plan, wherein executing the execution plan comprises performing an iterative process for each executable action of the one or more executable actions, and wherein the iterative process comprises:
identifying an action type for an executable action,
invoking one or more states configured to execute the action type, and
executing, by the one or more states, the executable action using an asset to obtain an output;
generating a second prompt based on the output obtained from executing each of the one or more executable actions; and
generating, by a second generative artificial intelligence model, a response to the natural language utterance based on the second prompt.

2. The computer-implemented method of claim 1, wherein:
creating the execution plan comprises performing an evaluation of the one or more executable actions;
the evaluation comprises evaluating the one or more executable actions based on one or more ongoing conversation paths initiated by the user and any currently active execution plans; and
creating the execution plan further comprises:
(i) when the evaluation determines that the natural language utterance is part of an ongoing conversation path, incorporating the one or more executable actions into a currently active execution plan associated with the ongoing conversation path, the currently active execution plan comprising an ordered list of the one or more executable actions and one or more prior actions, or
(ii) when the evaluation determines the natural language utterance is not part of an ongoing conversation path, creating a new execution plan comprising an ordered list of the one or more executable actions.

3. The computer-implemented method of claim 1, wherein the iterative process further comprises:
determining whether one or more parameters are available for the executable action;
when the one or more parameters are available, invoking the one or more states and executing the executable action based on the one or more parameters; and
when the one or more parameters for the executable action are not available, obtaining the one or more parameters that are not available and then invoking the one or more states and executing the executable action based on the one or more parameters.

4. The computer-implemented method of claim 3, wherein obtaining the one or more parameters comprises generating a natural language request to the user to obtain the one or more parameters for the executable action, and receiving a response from the user comprising the one or more parameters.

5. The computer-implemented method of claim 1, wherein:
invoking one or more states configured to execute the action type comprises:
invoking a first state to identify that the executable action has not yet been executed to generate a response, and
invoking a second state to determine whether one or more parameters are available for the executable action;
executing the executable action using the asset to obtain the output comprises invoking a third state to generate the output; and
the first state, the second state, and the third state are different from one another.

6. The computer-implemented method of claim 1, wherein generating the list comprises selecting the one or more executable actions from a list of candidate agent actions that are determined by using a semantic index, and wherein creating the execution plan further comprises:
identifying, based at least in part on metadata associated with candidate agent actions within the list of candidate agent actions, the one or more executable actions that provide information or knowledge for generating the response to the natural language utterance; and
generating a structured output for the execution plan by creating an ordered list of the one or more executable actions and a set of dependencies among the one or more executable actions.

7. The computer-implemented method of claim 6, wherein the iterative process further comprises determining that one or more dependencies exist between the executable action and at least one other executable action of the one or more executable actions based on the set of dependencies among the one or more executable actions, and wherein the executable action is executed sequentially in accordance with the one or more dependencies determined to exist between the executable action and the at least one other executable action.

8. A system comprising:
one or more processors; and
one or more computer-readable media storing instructions which, when executed by the one or more processors, cause the system to perform operations comprising:
generating, by a first generative artificial intelligence model, a list comprising one or more executable actions based on a first prompt comprising a natural language utterance provided by a user;
creating an execution plan comprising the one or more executable actions;
executing the execution plan, wherein executing the execution plan comprises performing an iterative process for each executable action of the one or more executable actions, and wherein the iterative process comprises:
identifying an action type for an executable action,
invoking one or more states configured to execute the action type, and
executing, by the one or more states, the executable action using an asset to obtain an output;
generating a second prompt based on the output obtained from executing each of the one or more executable actions; and
generating, by a second generative artificial intelligence model, a response to the natural language utterance based on the second prompt.

9. The system of claim 8, wherein:
the operation of creating the execution plan comprises performing an evaluation of the one or more executable actions;
the evaluation comprises evaluating the one or more executable actions based on one or more ongoing conversation paths initiated by the user and any currently active execution plans; and
the operation of creating the execution plan further comprises:
(i) when the evaluation determines that the natural language utterance is part of an ongoing conversation path, incorporating the one or more executable actions into a currently active execution plan associated with the ongoing conversation path, the currently active execution plan comprising an ordered list of the one or more executable actions and one or more prior actions, or
(ii) when the evaluation determines the natural language utterance is not part of an ongoing conversation path, creating a new execution plan comprising an ordered list of the one or more executable actions.

10. The system of claim 8, wherein the iterative process further comprises:
determining whether one or more parameters are available for the executable action;
when the one or more parameters are available, invoking the one or more states and executing the executable action based on the one or more parameters; and
when the one or more parameters for the executable action are not available, obtaining the one or more parameters that are not available and then invoking the one or more states and executing the executable action based on the one or more parameters.

11. The system of claim 10, wherein the operation of obtaining the one or more parameters comprises generating a natural language request to the user to obtain the one or more parameters for the executable action, and receiving a response from the user comprising the one or more parameters.

12. The system of claim 8, wherein:
the operation of invoking one or more states configured to execute the action type comprises:
invoking a first state to identify that the executable action has not yet been executed to generate a response, and
invoking a second state to determine whether one or more parameters are available for the executable action;
the operation of executing the executable action using the asset to obtain the output comprises invoking a third state to generate the output; and
the first state, the second state, and the third state are different from one another.

13. The system of claim 8, wherein the operation of generating the list comprises selecting the one or more executable actions from a list of candidate agent actions that are determined by using a semantic index, and wherein the operation of creating the execution plan further comprises:
identifying, based at least in part on metadata associated with candidate agent actions within the list of candidate agent actions, the one or more executable actions that provide information or knowledge for generating the response to the natural language utterance; and
generating a structured output for the execution plan by creating an ordered list of the one or more executable actions and a set of dependencies among the one or more executable actions.

14. The system of claim 13, wherein the iterative process further comprises determining that one or more dependencies exist between the executable action and at least one other executable action of the one or more executable actions based on the set of dependencies among the one or more executable actions, and wherein the executable action is executable sequentially in accordance with the one or more dependencies determined to exist between the executable action and the at least one other executable action.

15. One or more non-transitory computer-readable media storing instructions which, when executed by one or more processors, cause the one or more processors to perform operations comprising:
generating, by a first generative artificial intelligence model, a list comprising one or more executable actions based on a first prompt comprising a natural language utterance provided by a user;
creating an execution plan comprising the one or more executable actions;
executing the execution plan, wherein executing the execution plan comprises performing an iterative process for each executable action of the one or more executable actions, and wherein the iterative process comprises:
identifying an action type for an executable action,
invoking one or more states configured to execute the action type, and
executing, by the one or more states, the executable action using an asset to obtain an output;
generating a second prompt based on the output obtained from executing each of the one or more executable actions; and
generating, by a second generative artificial intelligence model, a response to the natural language utterance based on the second prompt.

16. The one or more non-transitory computer-readable media of claim 15, wherein:
the operation of creating the execution plan comprises performing an evaluation of the one or more executable actions;
the evaluation comprises evaluating the one or more executable actions based on one or more ongoing conversation paths initiated by the user and any currently active execution plans; and
the operation of creating the execution plan further comprises:
(i) when the evaluation determines that the natural language utterance is part of an ongoing conversation path, incorporating the one or more executable actions into a currently active execution plan associated with the ongoing conversation path, the currently active execution plan comprising an ordered list of the one or more executable actions and one or more prior actions, or
(ii) when the evaluation determines the natural language utterance is not part of an ongoing conversation path, creating a new execution plan comprising an ordered list of the one or more executable actions.

17. The one or more non-transitory computer-readable media of claim 15, wherein the iterative process further comprises:
determining whether one or more parameters are available for the executable action;
when the one or more parameters are available, invoking the one or more states and executing the executable action based on the one or more parameters; and
when the one or more parameters for the executable action are not available, obtaining the one or more parameters that are not available and then invoking the one or more states and executing the executable action based on the one or more parameters, wherein obtaining the one or more parameters comprises generating a natural language request to the user to obtain the one or more parameters for the executable action, and receiving a response from the user comprising the one or more parameters.

18. The one or more non-transitory computer-readable media of claim 15, wherein:
the operation of invoking one or more states configured to execute the action type comprises:
invoking a first state to identify that the executable action has not yet been executed to generate a response, and
invoking a second state to determine whether one or more parameters are available for the executable action;
the operation of executing the executable action using the asset to obtain the output comprises invoking a third state to generate the output; and
the first state, the second state, and the third state are different from one another.

19. The one or more non-transitory computer-readable media of claim 15, wherein the operation of generating the list comprises selecting the one or more executable actions from a list of candidate agent actions that are determined by using a semantic index, and wherein the operation of creating the execution plan further comprises:
identifying, based at least in part on metadata associated with candidate agent actions within the list of candidate agent actions, the one or more executable actions that provide information or knowledge for generating the response to the natural language utterance; and
generating a structured output for the execution plan by creating an ordered list of the one or more executable actions and a set of dependencies among the one or more executable actions.

20. The one or more non-transitory computer-readable media of claim 19, wherein the iterative process further comprises determining that one or more dependencies exist between the executable action and at least one other executable action of the one or more executable actions based on the set of dependencies among the one or more executable actions, and wherein the executable action is executable sequentially in accordance with the one or more dependencies determined to exist between the executable action and the at least one other executable action.
